(19) United States
(12) Patent Application Publication
(10) Pub. No.: US 2026/0342198 A1
(43) Pub. Date: Oct. 29, 2026

(54) METHOD AND APPARATUS FOR HERMETICALLY SEALED MAGNETIC GEARS AND MAGNETIC GEAR INTEGRATED MOTOR GENERATORS

(71) Applicant: FLUXWORKS, INC., Conroe, TX (US)

(72) Inventors: Bryton Praslicka, Houston, TX (US); Matthew Johnson, College Station, TX (US); Thomas Patrick Borum, Willis, TX (US); Nicholas Craig Newman, Lubbock, TX (US); Christopher Luke Gomez, Montgomery, TX (US); Kevin Hayden Sipple, The Woodlands, TX (US)

(21) Appl. No.: 19/701,542

(22) Filed: Jun. 8, 2026

Related U.S. Application Data
(63) Continuation of application No. PCT/US2024/059411, filed on Dec. 10, 2024.
(60) Provisional application No. 63/608,764, filed on Dec. 11, 2023.

(51) Int. Cl. H02K 49/10

(52) U.S. Cl. CPC H02K 49/102

(57) ABSTRACT

An electric machine may include a high-speed magnetic rotor. An electric machine may include a low-speed magnetic rotor maintained in a spaced relationship from the high-speed magnetic rotor. An electric machine may include a modulating structure disposed between the high-speed magnetic rotor and the low-speed magnetic rotor, so as to modulate a magnetic field of at least one of the high speed magnetic rotor and the low speed magnetic rotor; and wherein the modulator or the high-speed rotor are located in a sealed compartment.

### RELATED APPLICATIONS

This application is a continuation of International Application No. PCT/US2024/059411, filed Dec. 10, 2024, which claims the priority benefit of U.S. Provisional Patent Application 63/608,764 filed on Dec. 11, 2023, entitled “METHOD AND APPARATUS FOR HERMETICALLY SEALED MAGNETIC GEARS AND MAGNETIC GEAR INTEGRATED MOTOR GENERATORS,” which is incorporated by reference herein in its entirety.

### BACKGROUND

### Field

This disclosure relates to electric machines and magnetic gears. In particular, some implementations are directed to systems and methods for hermetically sealed magnetic gears and magnetic gear integrated motor generators.

### Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In normal actuator operation, transfer of rotary mechanical energy from the inside of a sealed environment to an external environment (or vice versa) can usually be accomplished with a rod and rod seal to separate and isolate the internal and external environments. This challenge becomes increasingly difficult in high-speed rotary applications.

### SUMMARY

For purposes of summarizing the disclosure and the advantages achieved over the prior art, certain objects and advantages of the disclosure are described herein. Not all such objects or advantages may be achieved in any particular implementation. Thus, for example, those skilled in the art will recognize that the devices, systems, and methods may be embodied or carried out in a manner that achieves or optimizes one advantage or group of advantages as taught herein without necessarily achieving other objects or advantages as may be taught or suggested herein.

All of these implementations are intended to be within the scope of the devices, systems, and methods herein disclosed. These and other implementations will become readily apparent to those skilled in the art from the following detailed description of the implementations having reference to the attached figures, the devices, systems, and methods not being limited to any particular implementations disclosed.

In some implementations, an axial flux magnetically geared machine can include: a high-speed magnetic rotor; a low-speed magnetic rotor maintained in a spaced relationship from the high-speed magnetic rotor; a modulating structure disposed between the high-speed magnetic rotor and the low-speed magnetic rotor, so as to modulate a magnetic field of at least one of the high-speed magnetic rotor and the low-speed magnetic rotor; and wherein one or more of the modulator and the high-speed rotor are located in a sealed compartment.

In some implementations, the sealed compartment includes a first sealed compartment and a second sealed compartment, and the modulator is located in a first sealed compartment and the high-speed rotor is located in a second sealed compartment. In some implementations, the modulating structure at least partially defines a wall of the sealed compartment.

In some implementations, the axial flux magnetically geared machine includes a stator located in the sealed compartment. In some implementations, the low-speed rotor is located outside of the sealed compartment. In some implementations, the low-speed rotor is not located inside of the sealed compartment. In some implementations, the low-speed rotor is mechanically coupled to a shaft. In some implementations, the low-speed rotor is mechanically coupled to a propeller.

In some implementations, an axial flux magnetically geared machine can include: a high-speed magnetic rotor; a low-speed magnetic rotor maintained in a spaced relationship from the high-speed magnetic rotor; a modulating structure disposed between the high-speed magnetic rotor and the low-speed magnetic rotor, so as to modulate a magnetic field of at least one of the high-speed magnetic rotor and the low-speed magnetic rotor; and wherein one or more of the modulator, the high-speed rotor, and the low-speed rotor are located in a sealed compartment.

In some implementations, the sealed compartment includes a first sealed compartment and a second sealed compartment, and the modulator is located in a first sealed compartment and the high-speed rotor is located in a second sealed compartment. In some implementations, the modulating structure at least partially defines a wall of the sealed compartment.

In some implementations, the axial flux magnetically geared machine include a stator located in the sealed compartment. In some implementations, the low-speed rotor is located outside of the sealed compartment. In some implementations, the low-speed rotor is not located inside of the sealed compartment. In some implementations, the low-speed rotor is mechanically coupled to a shaft. In some implementations, the low-speed rotor is mechanically coupled to a propeller.

In some implementations, an electric machine can include: a high-speed magnetic rotor; a low-speed magnetic rotor maintained in a spaced relationship from the high-speed magnetic rotor; and a modulating structure disposed between the high-speed magnetic rotor and the low-speed magnetic rotor, so as to modulate a magnetic field of at least one of the high-speed magnetic rotor and the low-speed magnetic rotor; wherein one or more of the modulator, the high-speed magnetic rotor, and the low-speed magnetic rotor are located in a sealed compartment.

In some implementations, the electric machine includes a stator and an electric machine rotor located in the sealed compartment, and wherein the electric machine rotor is mechanically affixed to the high-speed rotor. In some implementations, the sealed compartment includes a first sealed compartment and a second sealed compartment, and the modulator is located in a first sealed compartment and the high-speed rotor is located in a second sealed compartment. In some implementations, the modulating structure at least partially defines a wall of the sealed compartment. In some implementations, the electric machine includes a stator located in the sealed compartment.

In some implementations, the low-speed rotor is located outside of the sealed compartment. In some implementations, the low-speed rotor is not located inside of the sealed compartment. In some implementations, the low-speed rotor is mechanically coupled to a shaft. In some implementations, the low-speed rotor is mechanically coupled to a propeller. In some implementations, the electric machine includes a high-speed magnetic rotor hub coupled with the second electric machine having a stator and a plurality of permanent magnets mechanically affixed to the high-speed magnetic rotor with magnetic gear having a second plurality of permanent magnets; a low-speed magnetic rotor hub; and a modulating structure positioned between the high-speed magnetic rotor and the low-speed magnetic rotor; wherein the high-speed magnetic rotor hub, the low-speed magnetic rotor hub, and the modulating structure maintain a spaced relationship between the high-speed magnetic rotor and the low-speed magnetic rotor; and wherein the modulating structure is configured to modulate a magnetic field of at least one of the high-speed magnetic rotor and the low-speed magnetic rotor.

In some implementations, a magnetic gear can include: a first proximal rotor including a first plurality of permanent magnets disposed radially about a rotational axis, the first plurality of permanent magnets having a first plurality of pole pairs; a second distal rotor including a plurality of permanent magnets disposed radially about the rotational axis; and a stator including a plurality of soft magnetic pole pieces positioned so as to modulate the flux of the first and second plurality of pole pairs so as to create a geared magnetic coupling such that the rotation of the first rotor about the rotational axis imparts rotation of the second rotor about the rotational axis during operation of the axial flux magnetic gear.

In some implementations, the first proximal rotor includes a yoke of a soft magnetic composite. In some implementations, the first proximal rotor includes a yoke having through holes for fasteners to be used for retention or controlled axial distancing of the first proximal rotor from the stator. In some implementations, the first proximal rotor includes a plurality of magnetic pole pieces having chamfered shapes having a smaller face surface area on the side adjacent to the stator than the parallel face tangent to the yoke. In some implementations, the first proximal rotor includes nonmagnetic retaining elements to locate and compressively retain the permanent magnet pole pieces to the yoke.

In some implementations, the first proximal rotor contains tapped holes for fastener placement for retention. In some implementations, the second proximal rotor includes a yoke of a soft magnetic composite. In some implementations, the second proximal rotor includes a yoke having through holes for fasteners to be used for retention or controlled axial distancing of the second proximal rotor from the stator. In some implementations, the second proximal rotor includes a plurality of magnetic pole pieces having chamfered shapes having a smaller face surface area on the side adjacent to the stator than the parallel face tangent to the yoke.

In some implementations, the second proximal rotor includes nonmagnetic retaining elements to locate and compressively retain the permanent magnet pole pieces to the yoke. In some implementations, the second proximal rotor contains tapped holes for fastener placement for retention. In some implementations, the stator soft magnetic pole pieces are retained using a nonmagnetic material. In some implementations, the nonmagnetic retaining structure is shaped to include through holes for retention. In some implementations, the nonmagnetic retaining structure is shaped with locations for radial and axial loading bearings. In some implementations, the magnetic gear can include a first proximal magnetic rotor hub; a second distal magnetic rotor hub; a modulating structure positioned between the first proximal magnetic rotor and the second distal magnetic rotor; wherein the first proximal magnetic rotor hub, the second distal magnetic rotor hub, and the modulating structure maintain a spaced relationship between the first proximal magnetic rotor and the second distal magnetic rotor; and wherein the modulating structure is configured to modulate a magnetic field of at least one of the first proximal magnetic rotor and the second distal magnetic rotor.

In some implementations, a magnetic coupling can include: a first proximal rotor including a first plurality of permanent magnets disposed radially about a rotational axis, the first plurality of permanent magnets having a first plurality of pole pairs; a second distal rotor including a plurality of permanent magnets disposed radially about the rotational axis; a first proximal magnetic rotor hub including the first proximal rotor; and a second distal magnetic rotor hub including the second distal rotor; wherein the first proximal magnetic rotor hub and the second distal magnetic rotor hub maintain a spaced relationship between the first proximal rotor and the second distal rotor.

In some implementations, the first proximal rotor includes a yoke of a soft magnetic composite. In some implementations, retention or controlled axial distancing of the first proximal rotor. In some implementations, the first proximal rotor includes a plurality of magnetic pole pieces having chamfered shapes having a smaller face surface area on a side than the parallel face tangent to the yoke. In some implementations, the first proximal rotor includes nonmagnetic retaining elements to locate and compressively retain the permanent magnet pole pieces to the yoke. In some implementations, the first proximal rotor contains tapped holes for fastener placement for retention.

In some implementations, the second proximal rotor includes a yoke of a soft magnetic composite. In some implementations, the second proximal rotor includes a yoke having through holes for fasteners to be used for retention or controlled axial distancing of the second proximal rotor. In some implementations, the second proximal rotor includes a plurality of magnetic pole pieces having chamfered shapes having a smaller face surface area on a side than the parallel face tangent to the yoke. In some implementations, the second proximal rotor includes nonmagnetic retaining elements to locate and compressively retain the permanent magnet pole pieces to the yoke. In some implementations, the second proximal rotor contains tapped holes for fastener placement for retention. In some implementations, the first proximal rotor includes a high-speed magnetic rotor. In some implementations, the second distal rotor includes a low-speed magnetic rotor.

### BRIEF DESCRIPTION OF THE DRAWINGS

These and other features, aspects, and advantages of the disclosure are described with reference to drawings of certain implementations, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 illustrates a schematic implementation of the present disclosure in which the modulators in a compact axial flux magnetically geared electric machine are incorporated into a barrier, such as the wall of a pressure vessel.

FIG. 2 illustrates an embodiment of the present disclosure in which the modulators in a compact axial flux magnetically geared electric machine are incorporated into a barrier, such as the wall of a pressure vessel.

FIG. 3 illustrates an embodiment of the present disclosure in which a series-connected axial flux magnetically geared electric machine is incorporated into a barrier, such as the wall of a pressure vessel.

FIG. 4 illustrates a modular axial magnetic gearbox system for customizable assembly.

FIG. 5 illustrates a modular axial magnetic coupling system for customizable assembly.

### DETAILED DESCRIPTION

Although several implementations, examples, and illustrations are disclosed below, it will be understood by those of ordinary skill in the art that the devices, systems, and methods described herein extend beyond the specifically disclosed implementations, examples, and illustrations and include other uses of the devices, systems, and methods and obvious modifications and equivalents thereof. Implementations are described with reference to the accompanying figures, wherein like numerals refer to like elements throughout. The terminology used in the description presented herein is not intended to be interpreted in any limited or restrictive manner simply because it is being used in conjunction with a detailed description of some specific implementations of the devices, systems, and methods. In addition, implementations can comprise several novel features. No single feature is solely responsible for its desirable attributes or is essential to practicing the devices, systems, and methods herein described.

The present disclosure may be understood by reference to the following detailed description. It is noted that, for purposes of illustrative clarity, certain elements in various drawings may not be drawn to scale, may be represented schematically or conceptually, or otherwise may not correspond exactly to certain physical configurations of implementations.

Rotary seals in moving machinery are a frequent failure and pain point, which can result in critical system failure or undesirable design characteristics. By integrating soft magnetic modulator components within the structure of a magnetic gear or magnetically geared electric machine, these elements can serve as a barrier between different environments and the magnetic gear or magnetically geared electric machine can transmit flux across the barrier between rotors and consequently transmit rotary mechanical energy across the barrier without the use of a rotary seal. This arrangement can maintain a hermetic isolation between the environments on the different sides of the barrier, ensuring that there is no physical contact across the barrier. Thus, arranging the modulators or flux angle mapping pieces in a magnetic gear or magnetically geared electric machine into a barrier can eliminate the need for rotary seals in applications where rotary mechanical power needs to be transmitted across a boundary. Such a configuration can be advantageous in scenarios involving harsh conditions, where the integrity of rotary seals would otherwise be compromised over time due to wear, thermal stress, or chemical exposure. This could also be incorporated into any type of magnetic gear (magnetically geared electric machine) that utilizes flux modulation or flux angle mapping. This versatility allows for broader implementation across various industrial, aerospace, or energy applications where the maintenance-free transmission of rotary power and environmental isolation are design requirements. By replacing rotary seals with a magnetic-based solution, system reliability can be improved, downtime reduced, and overall efficiency enhanced.

An electric machine is a device that converts electrical energy into mechanical energy (or vice versa) using electromagnetic interactions, while a magnetic gear is a mechanical transmission system that transfers torque and speed between shafts through magnetic forces without physical contact. Electric machines or magnetic gears (magnetically geared electric machines) can include a high-speed low-torque rotor and a low-speed high-torque rotor. An electric machine can integrate an electric motor into a magnetic gear, resulting in a magnetically geared electric motor. An electric machine or magnetic gear can include a boundary between two regions (e.g., two sealed compartments). The boundary can be located between any components of the electric machine or magnetic gear. The electric machine or magnetic gear can be comprised of the integration of magnetic modulators or ferromagnetic pieces used for flux angle mapping into a boundary between the two regions. One example of an implementation is the integration of magnetic modulators in an axial flux magnetic gear into a pressure vessel. A pressure vessel configured to hold gases or liquids at a pressure substantially different from the ambient pressure, for example, a hermetically sealed reactor or storage tank, can include the disclosed magnetic gear by using it to transmit rotary mechanical power, such as driving agitators or pumps inside the vessel, while maintaining the pressure boundary without requiring traditional rotary seals that risk failure or leakage. This configuration allows the boundary (such as the pressure vessel wall) to remain static and allows flux to travel from one rotor in a magnetic gear or electric machine, which may be referred to as a magnetic gear integrated motor-generator, across the boundary to the other rotor in the magnetic gear or magnetically geared electric machine. As one example, the high-speed rotor in a magnetic gear or magnetically geared electric machine could be sealed inside a pressure vessel and the low-speed rotor in the magnetic gear or magnetically geared electric machine could be located on the outside of the pressure vessel.

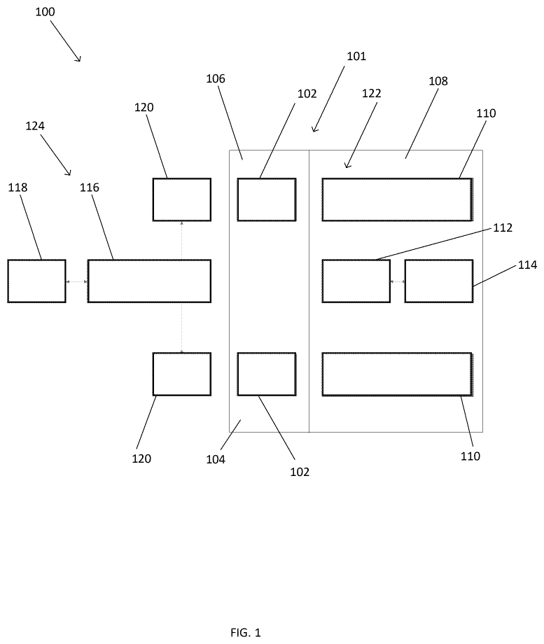

FIG. 1 illustrates a schematic block diagram 100 of an example compact axial flux magnetically geared electric machine 101. The entirety of U.S. Pat. No. 10,476,349 relating to compact axial flux magnetically geared electric machines is herein incorporated by reference. As shown in FIG. 1, the compact axial flux magnetically geared electric machine 101 can comprise modulators 102, which can be incorporated (e.g., integrated) into a barrier 104, such as the wall of a pressure vessel. The modulators 102 can enable the transmission of magnetic flux through the barrier 104, coupling internal and external mechanical systems without requiring physical contact. The modulators 102 can be made of a ferromagnetic material such as magnetic steel and can be comprised of a stack of magnetic steel laminations. The modulators 102 can modulate a magnetic field of at least one of an input element and/or an outer element. The modulators 102 can comprise a plurality of ferromagnetic pieces (e.g., soft magnetic pole pieces). The plurality of ferromagnetic pieces can be a single piece with a plurality of ferromagnetic sections. As such, it should be understood that the plurality of ferromagnetic pieces can also refer to a plurality of ferromagnetic sections. The plurality of ferromagnetic pieces can be spaced out within the soft magnetic pole pieces. The plurality of ferromagnetic pieces can be spaced out evenly, but they need not be. In between each individual ferromagnet of the plurality of ferromagnetic pieces, there may be a modulator gap. The modulator gap can be an air gap or it can be filled by another component and/or material.

The modulators 102 of the compact axial flux magnetically geared electric machine 101 can be located (e.g., housed) in a first sealed compartment 106, and a high-speed rotor 110 (e.g., a high-speed input element), a stator 112, which can be fixed, and/or motor permanent magnets (PMs) 114 can be located in a second sealed compartment 108. This separation between the first sealed compartment 106 and the second sealed compartment 108 can provide a hermetic isolation, with each compartment safeguarding its respective environment from cross-contamination and/or pressure loss. In some implementations, the first sealed compartment 106 and the second sealed compartment 108 can comprise a single compartment.

A shaft 116, a propeller 118, and/or a low speed rotor 120 (e.g., a low speed output element) can be located outside of the sealed compartments (e.g., the first sealed compartment 106 and the second sealed compartment 108) to form an interface for external mechanical work. This can allow for a drive mechanism 122, positioned within a sealed compartment (e.g., the first sealed compartment 106 and/or the second sealed compartment 108), to magnetically transmit rotary mechanical power to a drive means 124 located outside the sealed compartment (e.g., the first sealed compartment 106 and/or the second sealed compartment 108). This can be advantageous for applications requiring the separation of environments, such as the pressure vessel described above, by eliminating the need for rotary seals, thereby improving reliability and reducing maintenance requirements.

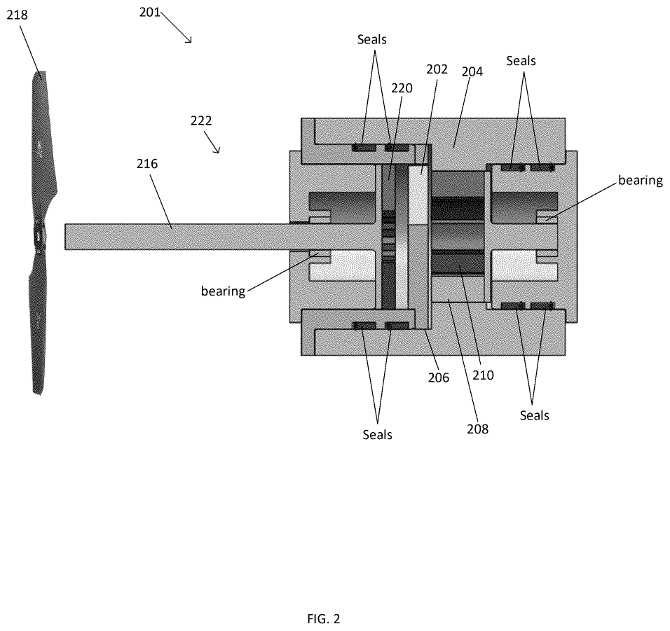

FIG. 2 illustrates a schematic side sectional view of an example compact axial flux magnetically geared electric machine 201. In this implementation of the present disclosure, modulators 202 of the compact axial flux magnetically geared electric machine 201 can be incorporated into a barrier 204, such as the wall of a pressure vessel. As shown in FIG. 2, the compact axial flux magnetically geared electric machine 201 can include modulators 202 located in a first sealed compartment 206. The compact axial flux magnetically geared electric machine 201 can also include a high-speed magnetic rotor 210 located in a second sealed compartment 208. In some implementations, the first compartment 206 and the second sealed compartment 208 can comprise a single compartment. The compact axial flux magnetically geared electric machine 201 can further comprise a low-speed magnetic rotor 220. The low-speed magnetic rotor 220 can be positioned at a fixed distance from the high-speed magnetic rotor 210, such that there is a gap between the high-speed magnetic rotor 210 and the low-speed magnetic rotor 220. The low-speed rotor can be connected to a shaft 216. Additionally, the low-speed rotor 220 can be connected to a propeller 218.

A modulating structure 222 can be disposed between the high-speed magnetic rotor 210 and the low-speed magnetic rotor 220. The modulating structure 222 can modulate a magnetic field of at least one of the high-speed magnetic rotor 210 and the low-speed magnetic rotor 220. Additionally, one or more of the modulators 202 and the high-speed magnetic rotor 210 can be located in a sealed compartment 205. In some implementations, the sealed compartment 205 comprises a first sealed compartment 206 and a second sealed compartment 208. The modulator 202 can be located in the first sealed compartment 206 and the high-speed magnetic rotor 210 can be located in the second sealed compartment 208. In some implementations, the modulators 202 at least partially define a wall 207 of the sealed compartment 205. The low-speed magnetic rotor 220 can be located outside of the sealed compartment 205. In some implementations,

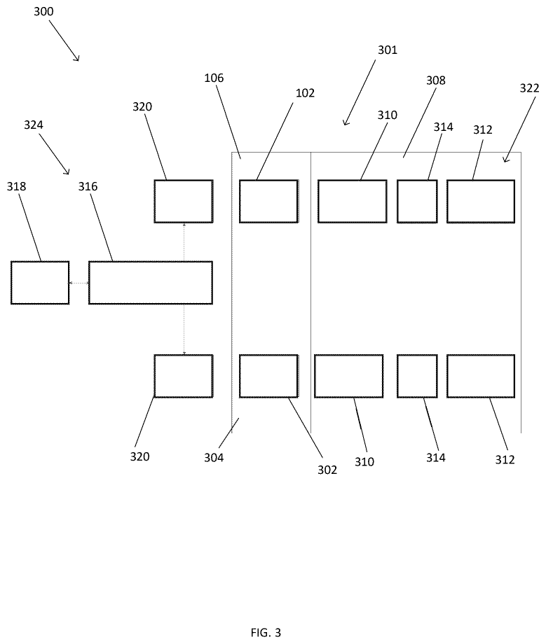

The compact axial flux magnetically geared electric machine 201 can further include a stator 212 located in the sealed compartment 205. In some implementations, the stator 212 and an electric machine rotor (not shown) are located in the sealed compartment 205. The electric machine rotor can be mechanically affixed to the high-speed rotor 210. In some implementations, the low-speed magnetic rotor 220 is not located inside of the sealed compartment 205. Alternatively, the concepts in this disclosure could be used with other magnetic gears or magnetically geared electric machine topologies, such as a series-connected axial flux magnetically geared electric machine, (see schematic block diagram 300 in FIG. 3).

FIG. 3 illustrates a schematic block diagram 300 of the present disclosure of the incorporation of modulators 302 in a series-connected axial flux magnetically geared electric machine 301 into a barrier 304 (e.g., the wall of a pressure vessel). The modulators 302 can be located in a first sealed compartment 306 and the high-speed magnetic rotor 310, stator 312, or motor permanent magnets (PMs) 314 can be located in a second sealed compartment 308. In some implementations, the first compartment 306 and/or the second compartment 308 can be a single compartment. A shaft 316, a propeller 318, and/or a low-speed magnetic rotor 320 can be located outside of the sealed compartments 306, 308. This can allow for a drive mechanism 122 to exist inside a sealed compartment and a drive means 124, driven by the drive mechanism 122, to exist outside of the sealed compartments 306, 308.

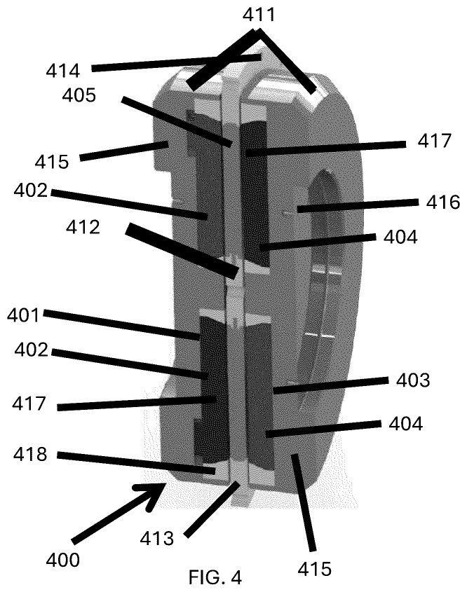

FIG. 4 illustrates an example axial flux magnetic gear 400. The magnetic gear 400 can comprise a first proximal rotor 401 comprising a first plurality of permanent magnets 402 disposed radially about a rotational axis and a second distal rotor 403 comprising a second plurality of permanent magnets 404 disposed radially about the rotational axis. The first plurality of permanent magnets 402 can have a first plurality of pole pairs, and the second plurality of permanent magnets 404 can have a second plurality of pole pairs. A stator 405 comprising a plurality of soft magnetic pole pieces can be positioned between the first proximal rotor 401 and the second distal rotor 403. The stator 405 can be configured to modulate a flux of the first and second plurality of pole pairs to create a geared magnetic coupling such that the rotation of the first proximal rotor 401 about the rotational axis imparts rotation of the second distal rotor 403 about the rotational axis during operation of the axial flux magnetic gear 400.

The magnetic gear 400 can also include hub assemblies 411, which can provide structural support and facilitate the mounting of the first proximal rotor 401 and/or second distal rotor 403. Disposed between the hub assemblies 411 can be the stator 405 comprising a modulator stator 412 in a nonmagnetic material 413. A nonmagnetic housing element 414 of the stator 405 can comprise holes for affixing the stator 405 to the hub assemblies 411. The magnetic rotor hub assemblies 411 can also each have a shaped yoke 415 comprised of a soft magnetic material, such as a soft magnetic composite. For example, the first proximal rotor 401 and/or second distal rotor 403 can comprise a yoke 415 of a soft magnetic composite. In some implementations, the shaped yoke 415 also comprises through holes 416 (e.g., tapped holes) for affixing the yoke 415 structurally. The through holes 416 can allow for fasteners to be used for retention or controlled axial distancing of the first proximal rotor 401 and/or the second distal rotor 403 from the stator 405.

The first proximal rotor 401 and/or second distal rotor 403 can further include chamfered permanent magnets 417, which can be magnetically attracted to the yokes 415. In some implementations, the chamfered permanent magnets 417 and yoke 415 are further affixed to one another through the inclusion of nonmagnetic axial retention elements 418. The chamfered permanent magnets 417 can have chamfered shapes having a smaller face surface area on the side adjacent to the stator 405 than the parallel face tangent to the yoke 415.

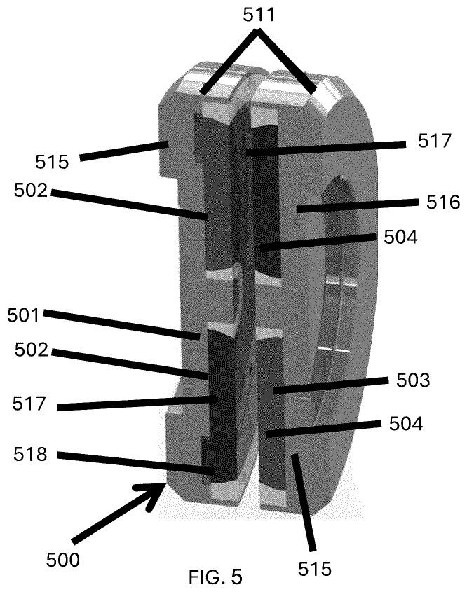

FIG. 5 illustrates an example axial flux magnetic coupling 500. The magnetic coupling 500 can comprise a first proximal rotor 501 comprising a first plurality of permanent magnets 502 disposed radially about a rotational axis and a second distal rotor 503 comprising a second plurality of permanent magnets 504 disposed radially about the rotational axis. The first plurality of permanent magnets 502 can have a first plurality of pole pairs, and the second plurality of permanent magnets 504 can have a second plurality of pole pairs. The first proximal rotor 501 and the second distal rotor 503 can comprise a coupling such that the rotation of the first proximal rotor 501 about the rotational axis imparts rotation of the second distal rotor 503 about the rotational axis during operation of the axial flux magnetic coupling 500.

The magnetic coupling 500 can also include hub assemblies 511, which can provide structural support and facilitate the mounting of the first proximal rotor 501 and/or second distal rotor 503. The magnetic rotor hub assemblies 511 can also each have a shaped yoke 515 comprised of a soft magnetic material, such as a soft magnetic composite. For example, the first proximal rotor 501 and/or second distal rotor 503 can comprise a yoke 515 of a soft magnetic composite. In some implementations, the shaped yoke 515 also comprises through holes 516 (e.g., tapped holes) for affixing the yoke 515 structurally.

The first proximal rotor 501 and/or second distal rotor 503 can further include chamfered permanent magnets 517, which can be magnetically attracted to the yokes 515. In some implementations, the chamfered permanent magnets 517 and yoke 515 are further affixed to one another through the inclusion of nonmagnetic axial retention elements 518. The chamfered permanent magnets 517 can have chamfered shapes having a smaller face surface area on a side than the parallel face tangent to the yoke 515.

In the foregoing specification, the systems and processes have been described with reference to specific implementations thereof. It will, however, be evident that various modifications and changes may be made thereto without departing from the broader spirit and scope of the implementations disclosed herein. The specification and drawings are, accordingly, to be regarded in an illustrative rather than restrictive sense.

Indeed, although the systems and processes have been disclosed in the context of certain implementations and examples, it will be understood by those skilled in the art that the various implementations of the systems and processes extend beyond the specifically disclosed implementations to other alternative implementations and/or uses of the systems and processes and obvious modifications and equivalents thereof. In addition, while several variations of the implementations of the systems and processes have been shown and described in detail, other modifications, which are within the scope of this disclosure, will be readily apparent to those of skill in the art based upon this disclosure. It is also contemplated that various combinations or sub-combinations of the specific features and implementations of the implementations may be made and still fall within the scope of the disclosure. It should be understood that various features and implementations of the disclosed implementations can be combined with, or substituted for, one another in order to form varying modes of the implementations of the disclosed systems and processes. Any methods disclosed herein need not be performed in the order recited. Thus, it is intended that the scope of the systems and processes herein disclosed should not be limited by the particular implementations described above.

It will be appreciated that the systems and methods of the disclosure each have several innovative implementations, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every implementation.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number, respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain implementations include, while other implementations do not include, certain features, elements and/or states. Thus, such conditional language is not generally intended to imply that features, elements and/or states are in any way required for one or more implementations.

While certain implementations have been described, these implementations have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative implementations may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various implementations described above can be combined to provide further implementations. The accompanying claims and their equivalents are intended to cover such forms or modifications as would fall within the scope and spirit of the disclosure.

Several illustrative examples of hermetically sealed magnetic gears and magnetic gear integrated motor generators and related systems and methods have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps may be arranged or performed differently than described and components, elements, features, acts, or steps may be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations may also be implemented in combination in a single implementation. Conversely, various features that are described in the context of a single implementation also may be implemented in multiple implementations separately or in any suitable subcombination. Moreover, although features may be described above as acting in certain combinations, one or more features from a claimed combination may in some cases be excised from the combination, and the combination may be claimed as a subcombination or variation of a subcombination.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures may or may not be drawn and/or shown to scale, but such scale should not be limiting, since dimensions and proportions other than what are shown are contemplated and are within the scope of the disclosed devices, systems, and methods. Distances, angles, etc. are merely illustrative and do not necessarily bear an exact relationship to actual dimensions and layout of the devices illustrated. Components may be added, removed, and/or rearranged. Further, the disclosure herein of any particular feature, aspect, method, property, characteristic, quality, attribute, element, or the like in connection with various examples may be used in all other examples set forth herein. Additionally, any methods described herein may be practiced using any device suitable for performing the recited steps.

For purposes of summarizing the disclosure, certain aspects, advantages and features of several devices, systems, and methods have been described herein. Not all, or any such advantages are necessarily achieved in accordance with any particular example of the devices, systems, and methods disclosed herein. No aspects of this disclosure are essential or indispensable. In many examples, the devices, systems, and methods may be configured differently than illustrated in the figures or description herein. For example, various functionalities provided by the illustrated modules may be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification may be included in any example.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain implementations require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the implementations shown herein but are to be accorded a fair interpretation consistent with this disclosure, the principles and the novel features disclosed herein.

1. An axial flux magnetically geared machine, comprising:
a high-speed magnetic rotor;
a low-speed magnetic rotor maintained in a spaced relationship from the high-speed magnetic rotor; and
a modulating structure disposed between the high-speed magnetic rotor and the low-speed magnetic rotor, so as to modulate a magnetic field of at least one of the high-speed magnetic rotor and the low-speed magnetic rotor;
wherein one or more of the modulating structure and the high-speed magnetic rotor are located in a sealed compartment.

2. The axial flux magnetically geared machine of claim 1, wherein the sealed compartment comprises a first sealed compartment and a second sealed compartment.

3. The axial flux magnetically geared machine of claim 2, wherein the modulating structure is located in the first sealed compartment and the high-speed magnetic rotor is located in the second sealed compartment.

4. The axial flux magnetically geared machine of claim 1, wherein the modulating structure at least partially defines a wall of the sealed compartment.

5. The axial flux magnetically geared machine of claim 1, further comprising a stator located in the sealed compartment.

6. The axial flux magnetically geared machine of claim 1, wherein the low-speed magnetic rotor is located outside of the sealed compartment.

7. The axial flux magnetically geared machine of claim 1, wherein the low-speed rotor is not located inside of the sealed compartment.

8. The axial flux magnetically geared machine of claim 1, wherein the low-speed rotor is mechanically coupled to a shaft.

9. The axial flux magnetically geared machine of claim 1, wherein the low-speed magnetic rotor is mechanically coupled to a propeller.

10. An axial flux magnetically geared machine, comprising:
a high-speed magnetic rotor;
a low-speed magnetic rotor maintained in a spaced relationship from the high-speed magnetic rotor; and
a modulating structure disposed between the high-speed magnetic rotor and the low-speed magnetic rotor, so as to modulate a magnetic field of at least one of the high-speed magnetic rotor and the low-speed magnetic rotor;
wherein one or more of the modulating structure, the high-speed magnetic rotor, and the low-speed magnetic rotor are located in a sealed compartment.

11. The axial flux magnetically geared machine of claim 10, wherein the sealed compartment comprises a first sealed compartment and a second sealed compartment.

12. The axial flux magnetically geared machine of claim 11, wherein the modulating structure is located in the first sealed compartment and the high-speed magnetic rotor is located in the second sealed compartment.

13. The axial flux magnetically geared machine of claim 10, wherein the modulating structure at least partially defines a wall of the sealed compartment.

14. The axial flux magnetically geared machine of claim 10, further comprising a stator located in the sealed compartment.

15. The axial flux magnetically geared machine of claim 10, wherein the low-speed magnetic rotor is located outside of the sealed compartment.

16. The axial flux magnetically geared machine of claim 10, wherein the low-speed magnetic rotor is not located inside of the sealed compartment.

17. The axial flux magnetically geared machine of claim 10, wherein the low-speed magnetic rotor is mechanically coupled to a shaft.

18. The axial flux magnetically geared machine of claim 10, wherein the low-speed magnetic rotor is mechanically coupled to a propeller.

19. An electric machine, comprising:
a high-speed magnetic rotor;
a low-speed magnetic rotor maintained in a spaced relationship from the high-speed magnetic rotor; and
a modulating structure disposed between the high-speed magnetic rotor and the low-speed magnetic rotor, so as to modulate a magnetic field of at least one of the high-speed magnetic rotor and the low-speed magnetic rotor;
wherein one or more of the modulating structure, the high-speed magnetic rotor, and the low-speed magnetic rotor are located in a sealed compartment.

20. The electric machine of claim 19, further comprising a stator and an electric machine rotor located in the sealed compartment, and wherein the electric machine rotor is mechanically affixed to the high-speed magnetic rotor.

21-57. (canceled)
